(19) United States
(12) Patent Application Publication
(10) Pub. No.: US 2023/0239692 A1
(43) Pub. Date: Jul. 27, 2023

(54) MACHINE TO MACHINE COMMUNICATION ACCELERATION VIA ENCRYPTION BYPASS

(71) Applicant: T-Mobile USA, Inc., Bellevue, WA (US)

(72) Inventors: Lyle Walter Paczkowski, Mission Hills, KS (US); George Jason Schnellbacher, Leawood, KS (US)

(21) Appl. No.: 17/581,793

(22) Filed: Jan. 21, 2022

(51) Int. Cl. H04W 12/069; H04W 12/0431; H04W 12/03; H04W 4/70

(52) U.S. Cl. CPC H04W 12/069; H04W 4/70; H04W 12/03; H04W 12/0431; H04W 84/06

(57) ABSTRACT

The disclosed technology provides systems and methods for accelerating communication for low latency, high reliability, and secure machine control systems through encryption bypass. Machine controllers, e.g., drone, robot, or autonomous-vehicle controllers, establish a hardware-based trust relationship with the controlled machines allowing for the communication of unencrypted low-latency control and data messages, for example, via ultra-reliable low latency (URLLC) cellular network slices. The machines can relay non-mission-critical communications via encrypted communication using different network slices. The machines can also use distributed ledgers to store and access events and records used to create and/or maintain the trust relationship, and archive data for subsequent use.

### BACKGROUND

Machine to machine (M2M) communication is direct communication between devices using wired and/or wireless communication channels and networks. M2M is closely related to the Internet of Things which describes physical objects (or groups of such objects) that are embedded with sensors, processing ability, software, and other technologies that connect and exchange data with other devices and systems over the Internet or other wireless or wired communications networks. M2M and IoT systems provide for the integration of communications, control, and information processing across various automation systems in transportation, industrial, home, etc., e.g., autonomous vehicles, aerial vehicles (drones), autonomous robots, factory automation systems, etc.

Security of the control and communication messages between M2M and IoT devices (e.g., between a drone or machine controller and the controlled drone or machine) is important and often relies on authentication, confidentiality, and integrity in the communication. Authentication allows a communication partner or peer to prove that it is really the device it claims to be (e.g., a drone controller to prove to the drone that it is the controller that the drone is intended to receive control commands from and send video streams to); confidentiality ensures that no other device but the addressed receiver(s) or link partner(s) can intercept or otherwise interpret the transmitted information; and integrity ensures that it is difficult or impossible to manipulate the control and data messages even where confidentiality is compromised (e.g., manipulating drone control messages or the data collected by the drone). One way to secure the communication channel is via encryption. Encryption is a means of securing digital data using one or more mathematical techniques, along with a password or “key” used to decrypt the information. The encryption process translates information using an algorithm that makes the original information unintelligible or otherwise unusable by devices without the key needed to decrypt the information.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates a communication path for a drone data and control communication.

FIG. 4A is a block diagram that illustrates a first control data path for wireless control systems.

FIG. 4B is a block diagram that illustrates a second control data path for wireless control systems.

FIG. 5 is a flow chart that illustrates a process for communicating ultra-reliable low latency data between two systems without encryption/decryption.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology provides systems and methods for machine to machine (M2M) type communication acceleration for autonomous machine control data sessions via encryption bypass. In one aspect of the disclosed technology, a machine controller, e.g., a drone, a robot, or an autonomous-vehicle controller, establishes a hardware-based trust relationship with the controlled machines or systems by sending/receiving key pairs at boot time to establish the trust relationship based on the key pairs and certificates of authority created by trusted entities. Based on the trust relationship, the systems are able to exchange mission-critical control and data messages without encryption thereby reducing network latency while continuing to communicate non-mission-critical data via encrypted messages. For example, the systems can use ultra-reliable low latency communications (URLLC) network slices for the low-latency encryption-bypassed communication channel and enhanced mobile broadband (eMBB) or massive internet of things (MIoT) network slices for the encrypted (higher latency) channel.

In another aspect of the disclosed technology, the systems (e.g., drone controller and drone) can post events or records associated with the communication and/or the trust relationship to a distributed ledger or can retrieve records from a distributed ledger that can be used to enable or sustain the trust relationship.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

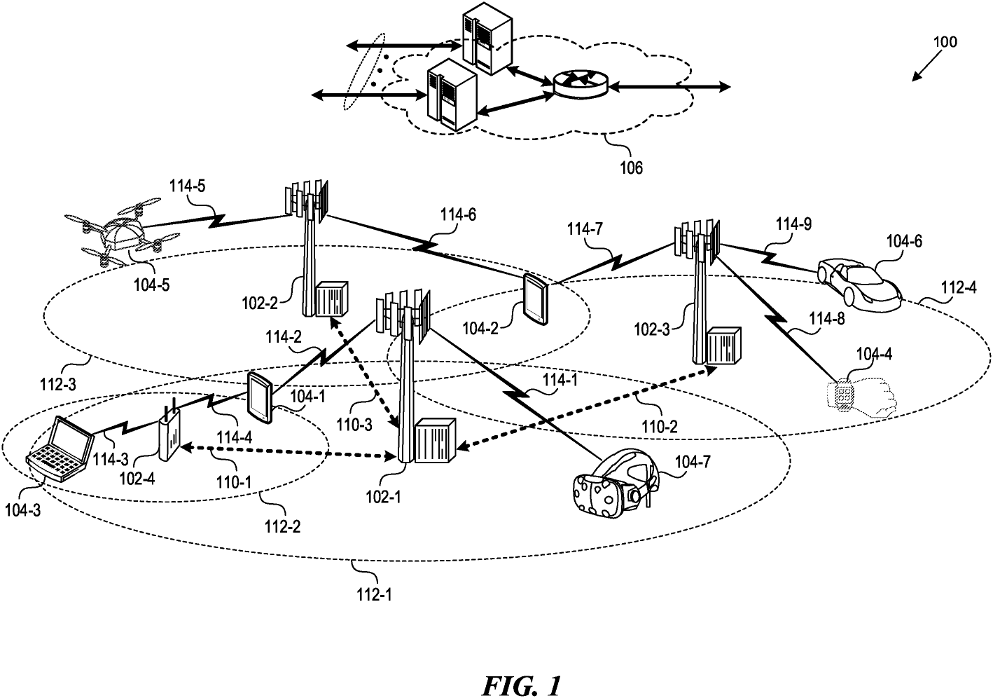

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the wireless telecommunications network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

### 5G Core Network Functions

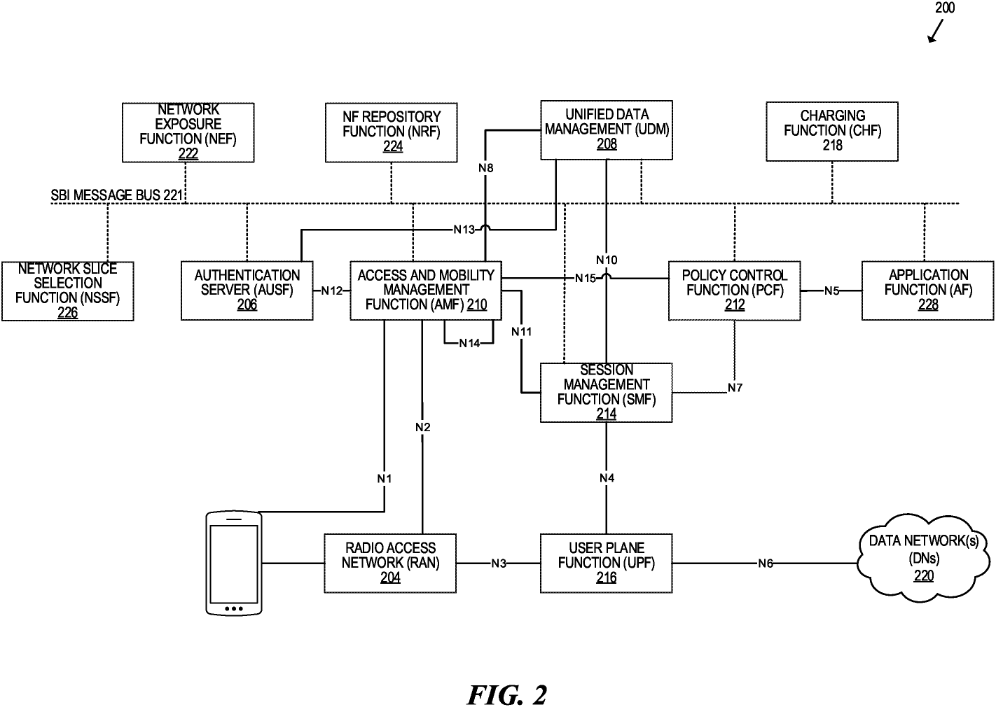

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224 a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make-up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

### Security in URLLC Applications

Ultra-reliable and low latency communications (URLLC) can open up new autonomous business operations including beyond visual line of sight drone flights, autonomous driverless vehicles, Industry 4.0 fully autonomous robots and machines, etc., which allows network operators to realize new business opportunities. Such URLLC applications typically require low latencies (e.g., end-to-end latency below 20 ms and even below 10 ms for some nascent applications) and extremely high reliability (e.g., guaranteed delivery of command-and-control messages associated with the applications with up to five-9s (99.999%) reliability or availability). In additional to low latency and high reliability, such applications also need to be cyber secure.

Certain wireless communication standards (e.g., 3GPP 4G LTE and 5G NR standards) address some aspects of low latency and reliability, for example, with network slicing and guaranteed bit rate delivery of data packets (e.g., as defined in quality of service (QOS) class identifiers (QCI) and 5G QOS identifiers (5QI)). However, such wireless standards do not address how to maintain low latency in a way that is highly secure particularly because adding security typically adds latency (e.g., use of virtual private networks (VPNs) with encryption on the transmission/sending side and decryption on the reception side adds latency to the data communication). There is therefore a need for system and methods to add or preserve security to URLLC data communications; to add security without substantially increasing latency and without negatively impacting reliability, or to decrease latency and increase reliability without negatively impacting security and trust between transmitter and receiver devices. For example, as described below, the disclosed technology provides for the use of advanced silicon features, e.g., Trust Zone and Cryptocells, to provide for hardware acceleration with encryption bypass.

A silicon-based hardware root of trust falls into two categories: fixed function and programmable. Essentially, a fixed-function root of trust is a state machine. These are typically compact and designed to perform a specific set of functions like data encryption, certificate validation and key management. These compact, state machine-based root of trust solutions are particularly well suited for Internet of Things (IoT) devices.

In contrast, a hardware-based programmable root of trust is built around a CPU. Performing all the functions of a state machine-based solution, a programmable root of trust can also execute a more complex set of security functions. A programmable root of trust is versatile and upgradable, enabling it to run entirely new cryptographic algorithms and secure applications to meet evolving attack vectors.

Arm and Intel processors have generally formed the basis to use a HROT. Arm with TEE and Intel uses SGX Software Guard Extension. Trusted Platform Module - TPM -The United States Department of Defense (DoD) specifies that “new computer assets procured to support DoD will include a TPM version 1.2 or higher where required by DISA STIGs and where such technology is available.” DoD anticipates that TPM is to be used for device identification, authentication, encryption, and device integrity verification. TPM is evident in computers and tablets generally although not widely deployed for non-DoD users.

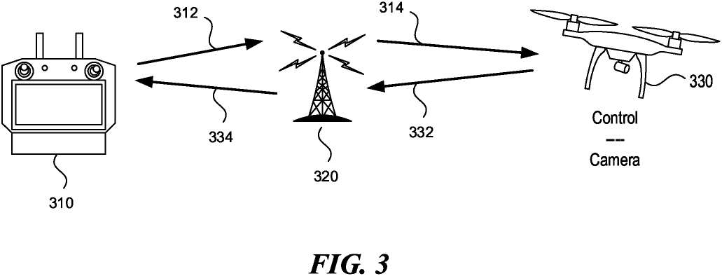

FIG. 3 is a block diagram that illustrates a drone data and control ultra-reliable low latency communication path. The disclosed technology allows for a low latency, reliable, and secure data/control communication path between drone controller 310 and the drone 330 via base station 320. That is, the disclosed technology provides for low latency, highly reliable, and secure paths 312 and 314 to send control/command and data to the drone 330 and low latency, highly reliable, and secure paths 332 and 334 to send data from the drone 330 (e.g., to send images, video, or other sensor data collected by the drone 330).

The communication path between controller 310 and drone 330 can be enabled by different wireless (or wired) networks including cellular radio access networks (e.g., 4G LTE, 5G NR, Wi-Fi, etc.) and can be based on different technologies such as non-standalone (NSA) or standalone (SA) 5G NR, citizen broadband radio service (CBRS) based spectrum sharing networks or other neutral host or private LTE/NR networks, satellite-based technologies, and other proprietary technologies suitable for URLLC applications.

In some implementations, the communication path between the controller 310 and drone 330 is a direct communication path that does not include an intermediate node (e.g., does not include base station 320). This can be based on, for example, direct-to-direct (D2D) or peer-to-peer communication systems (e.g., LTE/NR D2D, Wi-Fi direct, or other point-to-point or point-to-multipoint public or proprietary wireless protocols).

As described below, the disclosed encryption-bypass technology eliminates the need for encryption between the drone controller 310 and the drone 330 (e.g., eliminates the need for a VPN).

### Encryption Bypass

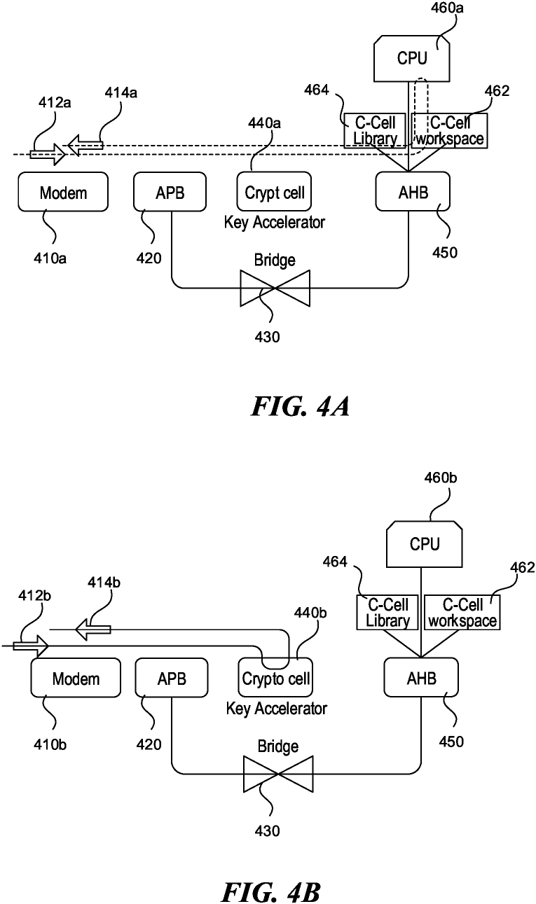

FIG. 4A is a block diagram that illustrates a first control data path for wireless control systems. The wireless control systems can be used for machines and systems that require precise and persistent network connectivity including autonomous vehicles (AVs), drones, robots, exoskeletons, manufacturing & factory automation tools, etc.

Other high science appliances (HAS) will have a similar requirement of indemnification. A HAS is a system that has several layers of capabilities. An autonomous car has real estate for spectrum radiation, it has several processors, a modem (or many modems), data storage capability, and significant electrical power generation capabilities. A low science appliance might be a refrigerator - minimal processing, narrow mission of use, and limited network access.

Indemnification describes that future actions of a HAS on the network 100 in FIG. 1 may have legal implications. Today a car might be owned by a corporation but in the future an autonomous car on network might be a corporation. The car’s risk will be high - particularly if the network and/or car cause a casualty. The refrigerator on the other hand poses lower risk and the level of indemnification needed will be lower.

The control system of FIG. 4A can include a complete on-board software platform for advanced remote machine control operations. For example, a drone controller (e.g., controller 310 in FIG. 3) can include a flight controller based on the PX4 autopilot open-source/open-hardware flight control software for drones and other unmanned vehicles, as well as an operating system running on a mission computer (not shown in FIG. 3) for advanced on-board functionality.

The control system of FIG. 4A can include an autonomy engine, payload control, video encoder and LTE/NR (or other wireless) connectivity (e.g., enabled by modem 41 0a). Additionally, the control system can include an Advanced Peripheral Bus (APB) 420, used for connecting low bandwidth peripherals, and an Advanced Microcontroller Bus Architecture (AMBA) High-performance Bus (AHB) 450. The APB is a non-pipelined protocol that can be used to communicate (read or write) from a bridge/host (e.g., bridge 430) to several clients or peripherals through a shared bus; the AHB enables parallel access paths between multiple masters and slaves in a system where access is resolved using priorities. The AHB and APB are part of the AMBA open-standard, on-chip interconnect specification for the connection and management of functional blocks in system-on-a-chips (SoCs). AMBA facilitates the development of multi-processor designs with large numbers of controllers and components with a bus architecture, where each bus master is connected to all the slave devices using an interconnection matrix.

In the control system of FIG. 4A, CPU 460a performs encryption/decryption of data. For example, encryption of data 414a to modem 410a (e.g., output data from the system to a peer system), and decryption of data 412a from modem 410a (e.g., input data from a peer system). In conventional control systems, such encryption/decryption can take up a large number of CPU cycles (e.g., thousands of CPU cycles) and is inherently slower than simply sending the data without encryption/decryption even where the system latency is primarily limited by the communications bandwidth rather than the CPU performance. For example, in the case of 5G NR bandwidth, an ultra-reliable low latency (URLLC) network slice can provide such low latency communication between the controller and controlled device such that the encryption/decryption latency becomes a significant percentage of the total end-to-end latency. For example, BitLocker encryption can take roughly 1 minute per every 500 mb or data encrypted.

In addition to the increase in latency added by encryption/decryption, the power used for encryption and decryption can decrease the power efficiency of certain battery-operated or otherwise low power control systems (e.g., low power autonomous control systems such as small-form factor systems operated by small/low-capacity batteries).

For example, although control data path is through CPU, the control system of FIG. 4A can use a different (e.g., light) encryption/decryption, such as light, instead of being bypassed entirely as in FIG. 4B.

FIG. 4B is a block diagram that illustrates a second control data path for wireless control systems. The control data path for output data 414b from the cryptocell 440b and input data 412b to the cryptocell 440b can overcome some of the problems with the control system of FIG. 4A, e.g., elimination of latency- and power-intensive encryption/decryption. CryptoCell complements TrustZone for Arm based processors and together these solutions form a Trusted Execution Environment (TEE).

The control data path in the control system of FIG. 4B allows for an accelerated manual, semi-autonomous, and autonomous machine control system for network connected devices using the compact communication path between processors of a controller and a controlled device that is different from the control path of FIG. 4A. The TEE ‘trustlet’ assumes the CPU task. The trustlets can be purpose built by the wireless telecommunication provider or integrator like an HROT integrator.

For example, when the control system of FIG. 4B is used in a drone controller and a drone (e.g., controller 310 and drone 330 of FIG. 3), the control data path of FIG. 4B can eliminate the need for encrypted messaging between the drone controller and the drone (e.g., between CPUs 460b in the drone controller and the drone). The control system depicted in FIGS. 4A-4B can be the control system in both the drone and the drone controller.

In some implementations, the data 412b/414b to/from the control system of FIG. 4B corresponds to a wireless communication signal communicated over a cellular communication network (or other wireless/wire-line network), e.g., via secure paths 312/314 and 332/334 between the drone 330 and drone controller 310. The data 412b/414b can use low latency and high priority QOS derivatives (e.g., high priority QCI/5QI) and can be processed and terminated at high security process stations without having a CPU or GPU perform encryption/decryption. An example of a high security process stations can be a modem that has processing power that is able to understand the data channel priority. Another example is a Smart NIC installed in a standard compute platform like high performance PCs or servers.

In some implementations, data 412b/414b can be split into different simultaneous data streams each served by a different 5G network slice (e.g., a different virtual network function (VNF)) each with different QOS requirements. For example, a data stream to provide control data (e.g., data from a drone controller used to control the operation of the drone); a data stream for operator video; a data stream for a public video feed; an archive data tap; an indemnification log, etc. The network slice policy, signaling, and network resource components can be initiated for each network slice during system boot. To accommodate the disclosed technology a wireless telecommunication network can instantiate a “smart slice or communication curtain” specifically for this type of rapid network access and transport. NSSF is a critical component in this process. The core of the network 100 in FIG. 1 does not need modification as the signaling is all that is needed to be modified. User Plane Function remains unaffected.

The disclosed technology can allow for some or all of the data streams to be encryption-bypassed to provide low latency, reliable and secure communication for those data streams. For example, the control data stream can be encryption-bypassed to allow for low latency control (e.g., highly responsive drone control) but the archive or indemnification log streams can continue to use conventional encryption/decryption for security given that low latency may be less important in these streams.

In some implementations, signal tokenization can be used to reduce the size of messages. For example, signal tokenization can be a simple command like “up” or “down” or “stop”, or some other data communication use. Signal tokenization (or reducing the size of messages) enables encryption bypass because it reduces the processing needed to create the ‘command’ within the OS. Further, sending a miniature bit sized command over the air without any prefix or suffix reduces communication costs in bandwidth, memory, and time.

In some implementations, the individual control system (e.g., control system of FIG. 4B) and/or individual appliances (e.g., drone controller 310 or drone 330 of FIG. 3) can have their designated unit and event identifiers (IDs) posted in a distributed ledger technology (DLT) system for trusted ID or an extension of DLT such as a specialized smart contract ledger systems, preservation of the network event, and other data archiving needs. The distributed ledger can also store the certificates of authority used to establish trust relationships between peer systems, the key pair exchanges, the control/data messages received, or other network events (e.g., notifications, faults, errors, interrupts, etc.) between the systems.

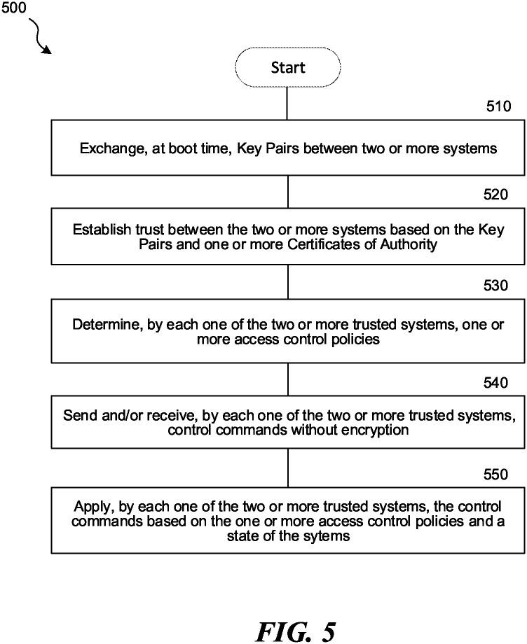

FIG. 5 is a flow chart 500 that illustrates a process for communicating ultra-reliable low latency data between two systems without encryption/decryption based on a hardware based management of roots-of-trust. The communicating systems (e.g., a drone controller and drone or other M2M systems) enforce different access control policies based on the state of the system/device using Certificates of Authority created by trusted entities and inserted into the secure enclaves of the controllers and slave units. Certificates of authority are generally written by third parties. In this, the network 100 in FIG. 1 can create their own Certificate of Authority and use TEE or SGX as the elements inserted into the enclaves.

At block 510, the two or more systems (e.g., the drone controller and the drone), exchange Key Pairs at boot time in peer-to-peer (or multicast) private networks to establish trust (e.g., send/receive key pairs via a wireless communication network such as an LTE/NR cellular network, Wi-Fi network, etc.).

In network protocol exchanges, it is often useful for one end of a communication to know whether the other end is in an intended operating state. At the time of booting, the systems can state their intention of network usage to obtain necessary authorization keys, and to establish the control data bypass route. Trusted enablement can then be established, the correct OS instructions can be given, and direct communication language’ can be established. Test patterns can be run to insure that the system is peer to peer. Once the validation is complete, the system can be authorized to proceed into the intended control path.

At block 520, the two or more systems (e.g., the drone controller and the drone) establish a trust relationship between each other based on the Key Pairs exchanged and further based on Certificates of Authority created by the trusted entities.

In some implementations, the systems can post one or more events associated with the trust relationship to a distributed ledger (e.g., a blockchain). For example, the systems can store a time when the trust relationship between the system and the peer system is created, an identity of the systems involved in the trust relationship, any communication errors or other interrupts generated by the trusted systems, etc.

In some implementations, the trust relationship itself is based on records stored in the DLT, for example, records posted by the systems into the DLT. In one embodiment, the DLT can be queried to ascertain rights, privileges, and leisure permissions and use this information to proceed with boot. For example, the DLT can store policy, authentication, authorization, accounting, and this information can be used to determine rights, privileges, and/or permissions. In another embodiment, the DLT might be used as an archive.

In some implementations, each of the systems includes a root of trust (RoT), e.g., a secure enclave or hardware security module (HSM), which is inaccessible outside the systems and which allows the peer system to determine that the information it receives from a peer is authentic (e.g., not from a man-in-the-middle).

In some implementations, the systems’ hardware (e.g., the security hardware in each of the controllers/slave devices) can be directly keyed to each other via trust zone (e.g., the device is provisioned by a network operator via application programming interfaces (APIs) to work with one or more other specific devices). Using trust zone isolation does not slow down the communication between peer systems. HROT can occur at the boot time and can hand off the trustlet once post is complete.

At block 530, the trusted systems (e.g., the drone controller with a hardware-based trust relationship with the drone) determine one or more access control policies. Examples of access control policies can include wireless access, and/or laser control, etc.

In some implementations, the trusted systems store the access control policies in a secure hardware module of the system (e.g., a secure enclave or HSM). The access control policies can identify the peer system that is allowed to send messages using conventional encryption/decryption.

At block 540, the systems send and/or receive control commands without requiring the Key Pairs exchanged at block 510 (e.g., without requiring encryption at the sender system and decryption at the receiver system). For example, the systems can exchange or encode messages in a way that only the paired trusted system understands and thus need not encrypt the messages. The encoding can be done using RAN.

At block 550, the one or more trusted systems (e.g., the drone controller in a trust relationship with or mated with the drone) applies, executes, or otherwise acts upon the received control commands based on the one or more access control policies determined and stored at block 530, and further based on the state of the systems. By establishing hardware-based trust at block 520, the disclosed technology at block 550 prevents an unauthorized device (e.g., a hacker) from remotely taking over command and control of the systems by ensuring that each system verifies that the messages it receives are from the trusted source and there is no unauthorized “man-in-the-middle” interceptions. The disclosed system provides an additional benefit by making the communication channel extremely difficult to see by an outsider. By bypassing encryption with the unencrypted control commands, the trusted systems can communicate with each other in a reliable, low latency, and low power mode and while ensuring security through authentication, confidentiality, and integrity in the communications.

The disclosed technology additionally ensure that the controller does not inadvertently control unintended systems or is not inadvertently controlled by unintended controllers (e.g., a drone controller does not inadvertently control a drone that it is not in a trust relationship with).

In some implementations, in addition to receiving the unencrypted control commands the systems can transmit/receive encrypted data messages (e.g., the drone controller can receive encrypted video, audio, or sensor data from the drone) where the encrypted data messages have higher latency requirements than the unencrypted control and data messages. For example, data to enable operations such as control messages and video streams to provide a real-time view for beyond visual line-of-sight drones can require lower latency than captured or collected video, images, and other data because delays in reacting to the operations data can result in anomalous drone operation.

In some implementations, as described above in relation to FIG. 4B, the different messages communicated between the systems can be associated with different 5G NR network slices. For example, the unencrypted (or encryption-bypassed) control and data messages can be communicated in a network slice corresponding to an ultra-reliable low latency communications (URLLC) slice service type. Conversely, the encrypted data messages can be communicated in a network slice corresponding to an enhanced mobile broadband (eMBB) service type if goal is high throughput communication (e.g., high bandwidth non-real-time video streams), or a massive internet of things (MIoT) slice service type if goal is long range communication.

### Computer System

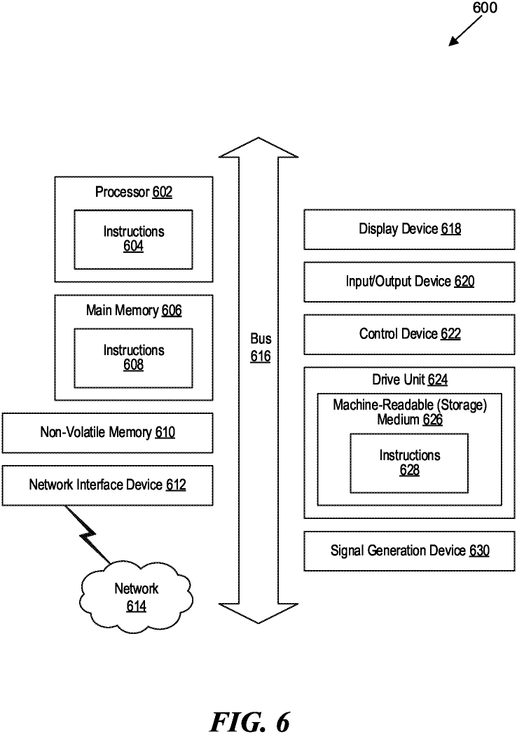

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementation, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. At least one computer-readable storage medium, excluding transitory signals and carrying instructions, which, when executed by at least one data processor of a system, cause the system to:
receive, by the system at boot time, key pairs from a peer system;
establish, by the system, a hardware-based trust relationship between the system and the peer system based on the key pairs and further based a certificate of authority;
determine, by the system, one or more access control policies;
receive, by the system, one or more control commands from the peer system,
wherein the one or more control commands are received without encryption;
receive, by the system, one or more data messages from the peer system,
wherein the one or more data messages are received with encryption, and
wherein a latency of the one or more control commands is lower than a latency of the one or more data messages;
apply, by the system, the one or more control commands based on the one or more access control policies and further based on a state of the system thereby causing the system to communicate with the peer system in an ultra-reliable, a secure, and a low latency mode.

2. The at least one computer-readable storage medium of claim 1, wherein the system is further caused to:
post one or more events associated with the trust relationship between the system and the peer system to a distributed ledger.

3. The at least one computer-readable storage medium of claim 1, wherein the trust relationship is based on one or more records stored in a distributed ledger.

4. The at least one computer-readable storage medium of claim 1, wherein the peer system comprises a drone, an autonomous vehicle, or an autonomous robot.

5. The at least one computer-readable storage medium of claim 1,
wherein the one or more control commands are associated with a first network slice and the one or more data messages are associated with a second network slice.

6. The at least one computer-readable storage medium of claim 5, wherein the first network slice comprises an ultra-reliable low latency communications (URLLC) slice service type, and the second network slice comprises an enhanced mobile broadband (eMBB) or a massive internet of things (MIoT) slice service type.

7. A method comprising:
send, through a wireless communication network, key pairs to a machine-to-machine (M2M) system;
establish a trust relationship with the M2M system based on the key pairs;
send one or more unencrypted control commands to the M2M system;
receive, in response to sending the one or more unencrypted control commands, one or more encrypted data messages from the M2M system,
wherein a latency of the one or more unencrypted control commands is lower than a latency of the one or more encrypted data messages.

8. The method of claim 7, further comprising:
posting one or more events associated with the trust relationship to a distributed ledger.

9. The method of claim 7, wherein the trust relationship is based on one or more records stored in a distributed ledger.

10. The method of claim 7, wherein the wireless communication network comprises a 4G LTE network, a 5G NR network, or a Wi-Fi network.

11. The method of claim 7, wherein the M2M system comprises an autonomous vehicle, a drone, or an autonomous robot.

12. The method of claim 7, wherein the one or more unencrypted control commands are associated with a first network slice and the one or more encrypted data messages are associated with a second network slice.

13. The method of claim 7, wherein the first network slice comprises an ultra-reliable low latency communications (URLLC) slice service type, and the second network slice comprises an enhanced mobile broadband (eMBB) or a massive internet of things (MIoT) slice service type.

14. A drone comprising:
at least one hardware processor; and
at least one non-transitory memory, coupled to the at least one hardware processor and storing instructions, which, when executed by the at least one hardware processor, cause the drone to:
receive key pairs from a drone controller at boot time;
establish a trust relationship with the drone controller based on the key pairs and further based a certificate of authority;
determine one or more access control policies in response to establishing the trust relationship;
receive one or more unencrypted control commands from the drone controller;
apply the one or more control commands based on the one or more access control policies thereby causing the drone to communicate with the drone controller in a low latency or a low power mode.

15. The drone of claim 14, wherein the drone is further caused to:
send one or more encrypted data messages to the drone controller,
wherein a latency of the one or more unencrypted control commands is lower than a latency of the one or more encrypted data messages.

16. The drone of claim 14, wherein the drone is further caused to:
post one or more events associated with the trust relationship to a distributed ledger.

17. The drone of claim 14, wherein the trust relationship is based on one or more records stored in a distributed ledger.

18. The drone of claim 14, wherein the drone is further configured to communicate with the drone controller via a 4G LTE, a 5G NR, or a Wi-Fi wireless communication network.

19. The drone of claim 15, wherein the one or more unencrypted control commands are associated with a first network slice and the one or more encrypted data messages are associated with a second network slice.

20. The drone of claim 19, wherein the first network slice comprises an ultra-reliable low latency communications (URLLC) slice service type, and the second network slice comprises an enhanced mobile broadband (eMBB) or a massive internet of things (MIoT) slice service type.
